(19) United States
(12) Patent Application Publication
(10) Pub. No.: US 2019/0212912 A1
(43) Pub. Date: Jul. 11, 2019

(54) METHOD FOR OPERATING A HUMAN-MACHINE INTERFACE AND HUMAN-MACHINE INTERFACE

(71) Applicant: BCS AUTOMOTIVE INTERFACE SOLUTIONS GMBH, Radolfzell (DE)

(72) Inventors: DAVID ABT, Radolfzell (DE); SOEREN LEMCKE, Gundholzen (DE); NIKOLAJ POMYTKIN, Konstanz (DE)

(21) Appl. No.: 16/238,961

(22) Filed: Jan. 3, 2019

(30) Foreign Application Priority Data
Jan. 5, 2018 (DE) 102018100196.7

(51) Int. Cl. G06F 3/0488; G06F 3/0482

(52) U.S. Cl. CPC G06F 3/04886; B60K 37/06; G06F 2203/04808; G06F 3/0482

(57) ABSTRACT

A method for operating a human machine interface for a vehicle comprising a control unit and at least one selection area designed as a touch-sensitive surface and at least one operating area designed as a touch-sensitive surface, wherein said at least one selection area and said at least one operating area are separated from each other, has the following steps:
a) a touch on at least one arbitrary contact point of said at least one operating area is recognized,
a) the number of fingers touching said at least one selection area is determined, and
b) a button, by means of which an input is possible, is assigned to said at least one arbitrary contact point on said at least one operating area,
   wherein a function is assigned to the button, said function being selected depending on the number of fingers that touch said at least one selection area.

### RELATED APPLICATION

The present invention claims priority of DE 10 2018 100 196.7, filed on 5 Jan. 2018, the entirety of which is incorporated herein by reference.

### FIELD OF THE DISCLOSURE

The disclosure concerns a method for operating a human machine interface for a vehicle as well as a human machine interface for a vehicle.

### BACKGROUND

Human machine interfaces for vehicles are well-known and increasingly comprise a touch-sensitive surface. However, in comparison to the operation of physical buttons, the user has to pay more attention when operating touch-sensitive surfaces, which can distract the user, particularly from traffic situations.

For this reason, important functions or frequently used functions can often each be accessed by a separate physical button of a human machine interface in the vehicle. Space requirements increase, however, as an individual physical button must be provided for each function.

### SUMMARY

Thus, there is a need to provide a method for operating a human machine interface as well as a human machine interface that not only allow simple access to a multitude of functions, but also require little space.

The object is achieved by a method for operating a human machine interface for a vehicle comprising a control unit and at least one selection area designed as a touch-sensitive surface and at least one operating area designed as a touch-sensitive surface, wherein said at least one selection area and said at least one operating area are separated from each other, comprising the following steps:
a) a touch is recognized on at least one arbitrary contact point of said at least one operating area,
b) the number of fingers touching said at least one selection area is determined, and
c) a button by means of which an input is possible is assigned to said at least one arbitrary contact point on said at least one operating area,

wherein a function is assigned to the button, said function being selected depending on the number of fingers touching said at least one selection area.

In this way, the number of functions that the user of the human machine interface can quickly access can be increased considerably without requiring more attention to do so. After a brief familiarization phase, the user can operate the human machine interface without any significant eye movements.

In this case, the term “separate” or “separated from each other” refer to spatially separate touch-sensitive areas and/or separate area controllers of the touch-sensitive areas which determine the contact positions.

Said at least one selection area and said at least one operating area are in particular physical operating areas that each constitute a separate touch-sensitive surface. The different terms “selection area” and “operating area” are solely used to make a better distinction.

Of course, the finger may also be a stylus or something similar. Touching the touch-sensitive surfaces with the heel of the hand can be recognized and ignored by the control unit.

For example, the position and/or the function of a button or of several buttons are displayed by at least one optical element on the operating surface. By this means, the user receives visual feedback, thus simplifying the operation.

In an embodiment of the disclosure, the number of fingers on the selection area is used for selecting the function of the button, said number of fingers being determined the moment the operating area is touched, a predetermined period before or during the period of the touch. In this way, input errors are prevented.

For example, the number of fingers on the selection area is determined repeatedly anew and the function of the button is adapted if necessary, thus enabling the human machine interface to process user inputs quickly. In this case, “repeatedly” means regularly or continuously.

In an embodiment of the disclosure, several simultaneous touches, in particular by several fingers on several contact points of the operating surface, are recognized, wherein each command button each comprising a function is assigned to at least the contact points on the operating area, thus increasing the number of quickly accessible functions further. As a result, the selection of functions can take place depending on the number of fingers on the selection area.

Preferably, functions that are assigned to the different contact points when touched simultaneously constitute a set of functions, wherein the used set of functions was selected depending on the number of fingers on said at least one selection area. Functions can be combined in this way and thus each function must not be loaded separately.

In order to adapt the use to the ergonomics of a human hand, each set of functions can comprise three functions that are assigned to the buttons of three adjacent contact points, in particular to the buttons whose contact points have been generated by the thumb, index finger or middle finger of the user's hand.

In a variant, the finger operating the selection area and/or the operating area is recognized, wherein the function and/or the set of functions are selected depending on the finger used. As a result, the number of quickly available functions can be increased further.

In order to increase the number of functions even more, the hand operating the selection area and/or the operating area is recognized, wherein the function and/or the set of functions are selected depending on the hand used.

In addition, the object is achieved by a human machine interface for a vehicle, which is configured in particular for the purpose of executing the method according to any of the preceding claims, comprising a control unit and at least one selection area designed as a touch-sensitive surface and at least one operating area designed as a touch-sensitive surface, wherein said at least one selection area and said at least one operating area are separated from each other and connected to the control unit for the purpose of transmitting data. At least one button, to which a function is assigned, is provided on the operating surface during operation of the human machine interface, said function being selected depending on the number of fingers on said at least one selection area.

In the case of several touches on several contact points at the same time, several buttons can be provided, wherein each button is located on each one of the contact points being touched.

For example, the selection area and/or the operating area comprise an area controller that recognizes the number and position of at least one touch on the selection area or operating area assigned to it, wherein the area controller is connected to the control unit in order to transmit the number and the position of the at least one touch on the touch-sensitive surface assigned to it. In this way, cost-efficient standard components for the selection area and/or the operating area can be used.

For example, the position of the button is determined by the control unit in such a way that on touching the operating surface on any contact point, the position of the button is set by the control unit to the contact point that was touched, thus facilitating ease of use.

In a variant, said at least one button is operated via renewed touch, increasing the pressure and/or shifting the contact point, thus facilitating ease of use. In particular, the operation may be carried out using gestures, for example via “drag”, i.e. shifting the contact points without subsequently lifting the finger.

The selection area and the operating area can be provided on different sides of a seat, in particular the driver's seat, in order to enable operation without any large arm movements.

To always provide the user a selection area and an operating area within reach, the human machine interface can comprise at least a vehicle component, wherein the selection area and the operating area are located on said at least one vehicle component, in particular wherein several vehicle components are provided, wherein the selection area and the operating area are located on different vehicle components.

For example, the operating area extends over at least 50%, in particular at least 75% of the surface of the respective vehicle component.

The operating area can be located under a decorative surface of the vehicle component.

Alternatively or additionally, the operating surface and/or the vehicle component can comprise a mechanical feedback element for haptic feedback, in particular a vibration motor, a pressure resistance device and/or an ultrasonic source.

In a variant, the vehicle component is a steering wheel, a seat, a control stick, a door trim, an armrest, a part of a center console, a part of a dashboard and/or a part of an overhead trim. As a result, the user can always reach the operating area and the selection surface easily.

In order to distract the user as little as possible, the human machine interface comprises an output screen that is located spatially separated from the selection area, the operating area and/or the vehicle component, wherein the function of said at least one button is displayed on the output screen.

### DESCRIPTION OF THE DRAWINGS

Additional features and advantages of the disclosure can be found in the following description as well as the attached drawings to which reference is made. In the drawings:

FIG. 1a) shows a perspective view of a cockpit of a vehicle that is provided with a human machine interface according to the disclosure,

FIG. 1b) shows a schematic sectional view of part of the cockpit according to FIG. 1a) in the area of an operating surface of the human machine interface,

FIG. 2 shows a schematic wiring diagram of part of the human machine interface according to FIG. 1, and

the FIGS. 3a) to 3d) as well as 4a) to 4b) show illustrations of the method according to the disclosure.

### DETAILED DESCRIPTION

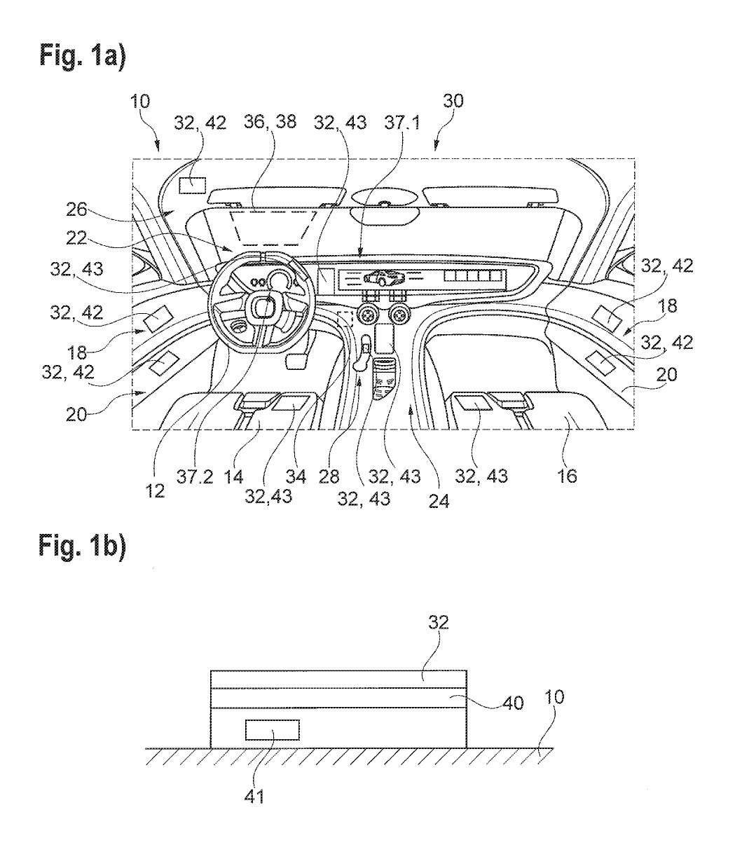

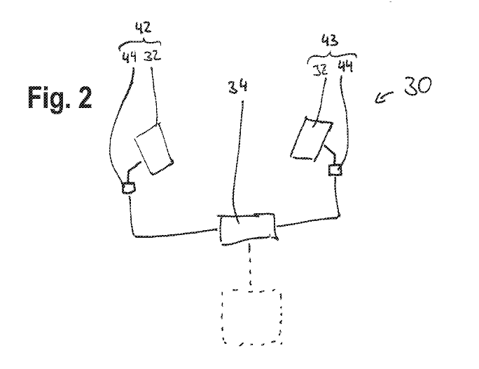

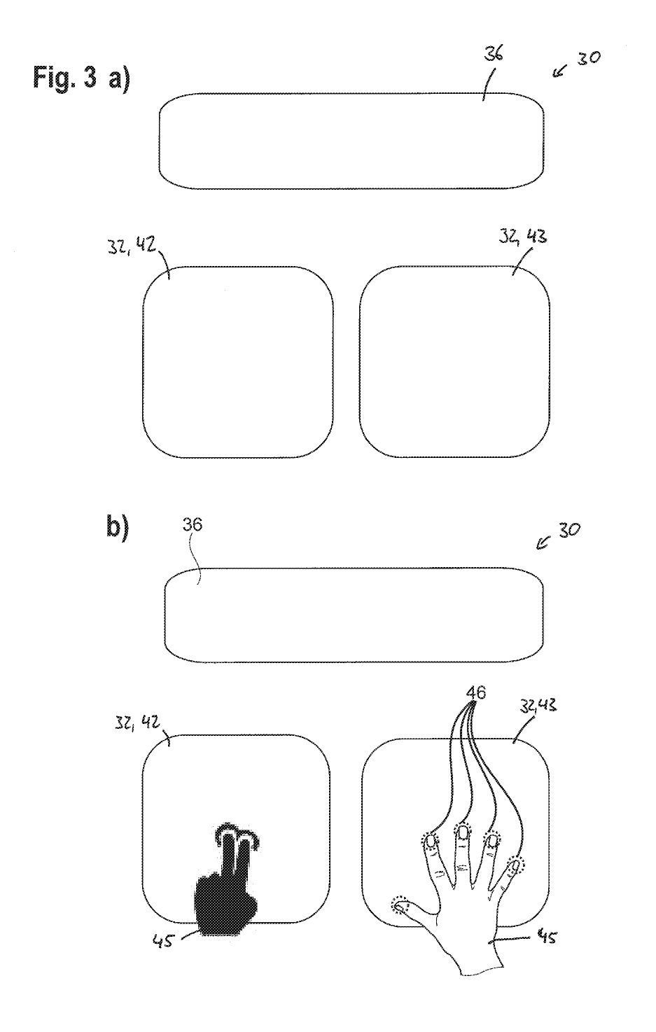

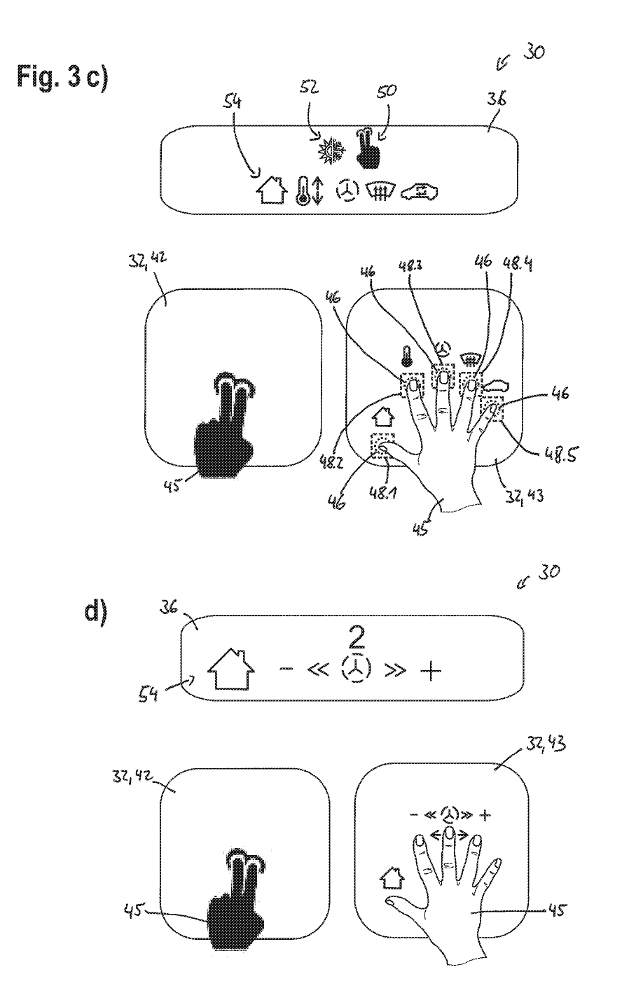

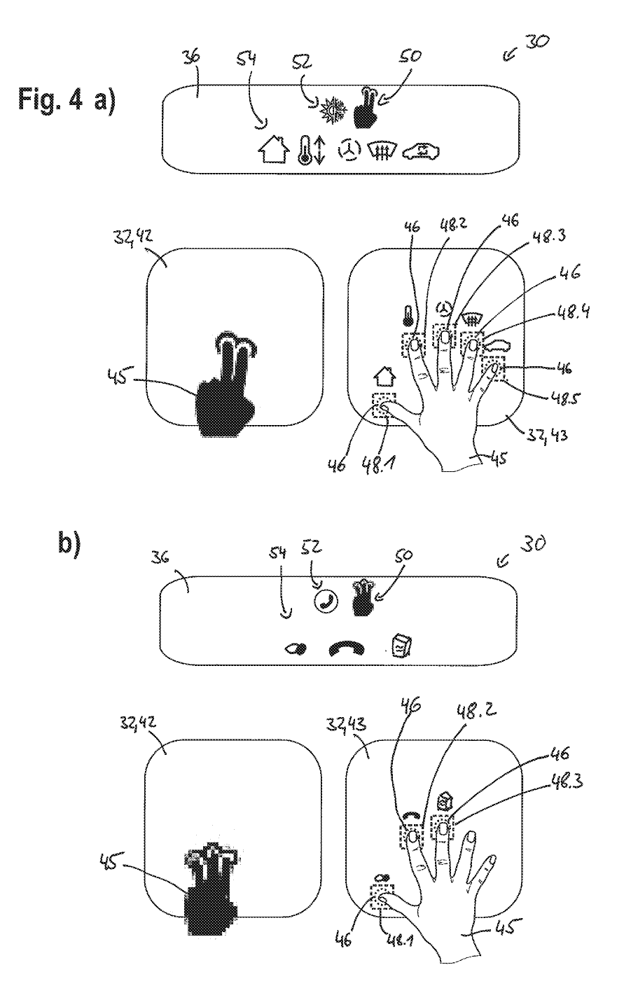

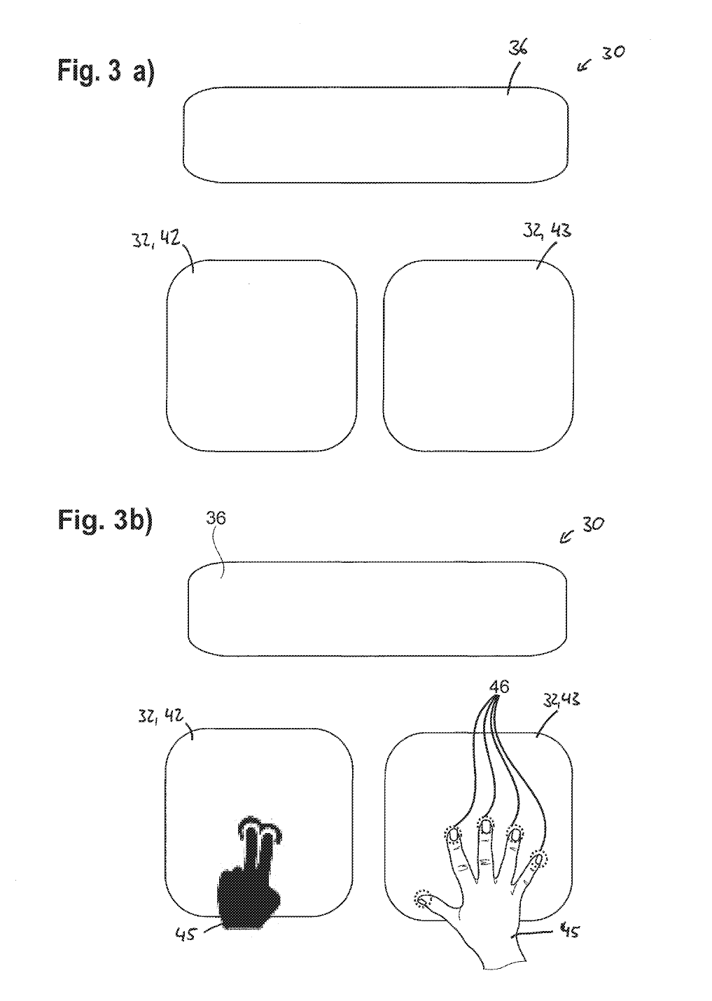

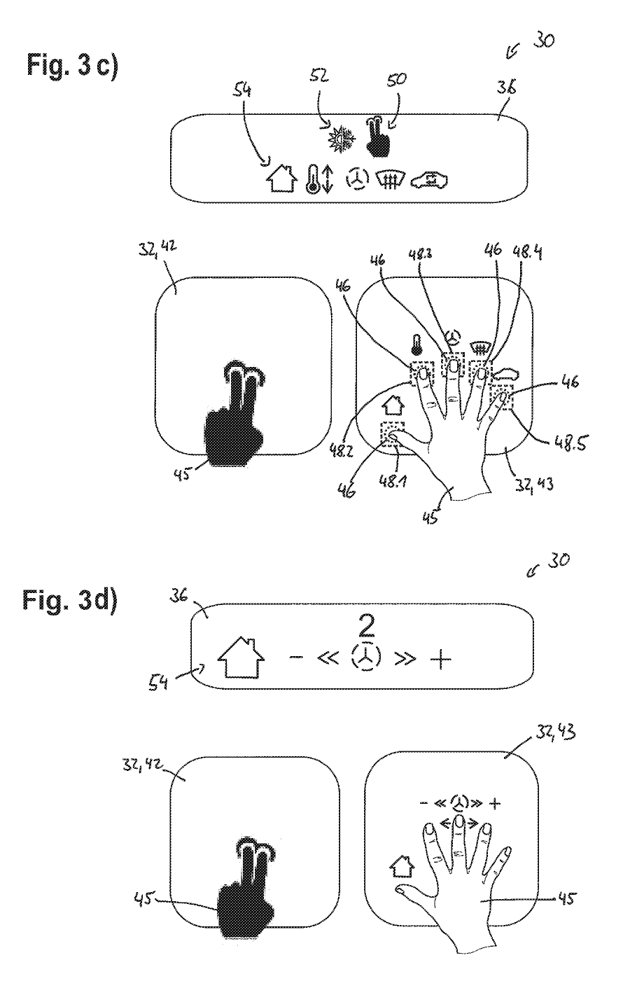

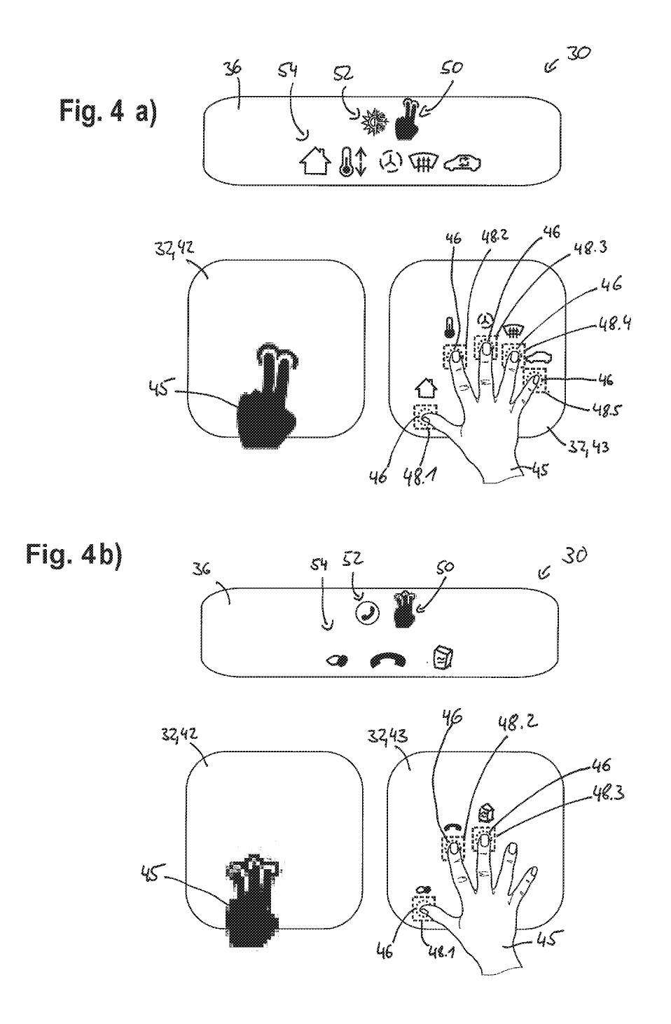

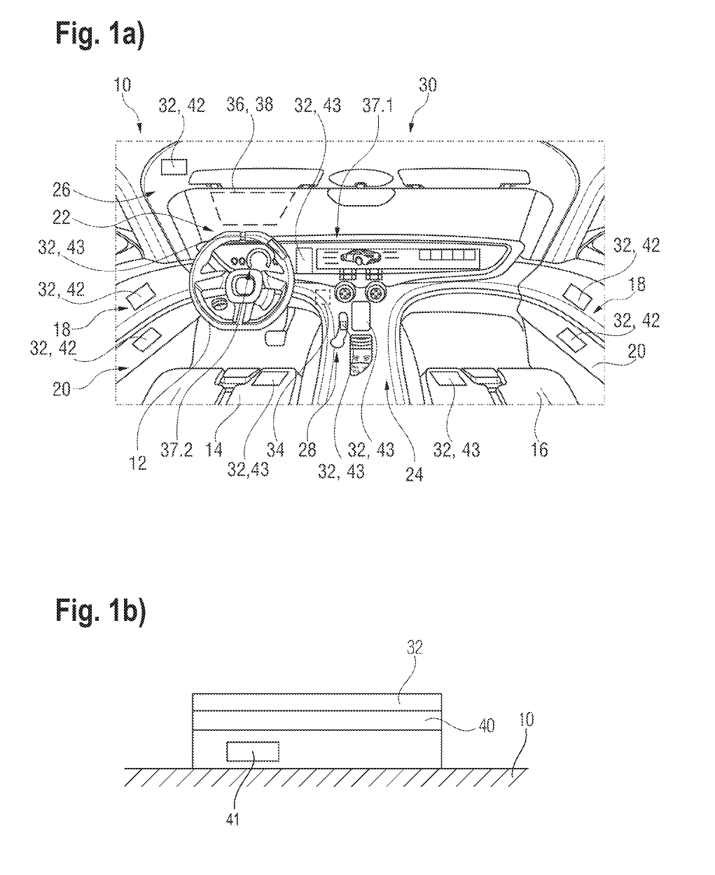

In FIG. 1a) the cockpit of the vehicle is shown.

The cockpit comprises different vehicle components 10 in the conventional manner, such as a steering wheel 12, a driver's seat 14, a front passenger seat 16, door trims 18, armrests 20, a dashboard 22, a center console 24 and/or overhead trims 26.

Furthermore, a control stick 28 may be provided in the cockpit.

Moreover, the cockpit has a human machine interface 30 that comprises several touch-sensitive surfaces 32, a control unit 34 and several output screens 36 in the shown embodiment.

The control unit 34 is connected to the output screens 36 and the touch-sensitive surfaces 32 for the purpose of transmitting data. This can occur by means of a cable or wirelessy.

In FIG. 1a), two screens 37.1, 37.2 are provided in the dashboard 22 as output screens 36 and a screen of a head-up display 38 (HUD) also serves as an output screen 36.

In the shown embodiment, the human machine interface 30 comprises eleven touch-sensitive surfaces 32 on different vehicle components 10. The vehicle components 10, on which the touch-sensitive surfaces 31 are provided, are part of the human machine interface 30 in this case.

However, the number of touch-sensitive surfaces 32 is only to be seen as an example. The human machine interface 30 can also be designed with any number of touch-sensitive surfaces 32.

In the shown embodiment, the touch-sensitive surfaces 32 are located on each one of the door trims 18 of the driver's door or the front passenger door or on the corresponding armrests 20.

A touch-sensitive surface 32 is also located on the overhead trim in the driver's area.

Another touch-sensitive surface 32 is provided on the steering wheel 12, the touch-sensitive surface 32 being shown on the front of the steering wheel 12 in FIG. 1a). It is also possible and advantageous if the touch-sensitive surface 32 extends on the rear of the steering wheel 12 or is only provided there.

Furthermore, one touch-sensitive surface 32 is provided in the dashboard 22 and one in the center console 24.

Touch-sensitive surfaces 32 are also located on the driver's seat 14 and the front passenger seat 16 and serve in particular to adjust the seat. As an illustration, these touch-sensitive surfaces 32 are shown on the upper side of the seats 14, 16. However, these can also be located on the side of the seats 14, 16 at the usual positions for seat adjustment devices.

At least one touch-sensitive surface 32 is also provided on the control stick 28. For example, the touch-sensitive surface 32 on the control stick 28 is divided into different areas that are provided at places on the control stick 28, against which the user's fingertips rest.

As an illustration, the depicted touch-sensitive surfaces 32 are each shown as being spatially extremely delimited. Of course, the touch-sensitive surfaces 32 can also be considerably larger and cover, for example, at least 50%, in particular at least 75% of the surface of the respective vehicle component 10. In this regard, only the surface of the respective vehicle component 10 facing the car interior is taken into consideration.

For example, the touch-sensitive surface 32 can be provided above or below a decorative surface of the respective vehicle component 10 so that large touch-sensitive surfaces 32 can be designed in a visually attractive way. The operating surface can comprise a touch-sensitive film.

Of course, at least one of the touch-sensitive surfaces 32 can be designed together with one of the output screens 36 as a touch display.

In FIG. 1b), one touch-sensitive surface 32 is shown on a vehicle component 10 in section as an example.

The touch-sensitive surface 32 is not attached directly to the vehicle component 10 in the shown embodiment, but an optical element 40, in this case another screen, is provided under the touch-sensitive surface 32. The optical element 40 can also be, however, a LED matrix or individual LEDs.

The screen and the touch-sensitive surfaces 32 form together a touch-sensitive touch display, such as is well-known from smartphones or tablets. It is, of course, also conceivable that the sequence of touch-sensitive surfaces 32 and the optical element 40 is exchanged and/or a protective layer is provided on the exterior in addition.

Moreover, a mechanical feedback element 41 is provided between the touch-sensitive surface 32 and the vehicle component 10. In the shown embodiment, this is a vibration motor that can cause the touch-sensitive surface 32 to vibrate.

It is also conceivable that the mechanical feedback element 41 is a pressure resistance device, such as is well-known from physical buttons (e.g. on a keyboard). The pressure resistance device can generate a specific pressure point by means of a mechanical counterforce to produce a haptic feedback when pressing the touch-sensitive surface 32.

However, it is also conceivable that the mechanical feedback element 41 is an ultrasonic source that emits ultrasonic waves in the direction of a user's fingers to produce a haptic feedback when operating the touch-sensitive surface 32.

The human machine interface 30 comprises several selection areas 42 and operating areas 43 that are formed by the touch-sensitive surfaces 32. To this end, some of the touch-sensitive surfaces 32 are designed as selection areas 42 and the remaining touch-sensitive surfaces 32 as operating areas 43.

However, it is also conceivable that the assignment, whether a touch-sensitive surface 32 is a selection area 42 or an operating area 43, is dynamic and depends on which two touch-sensitive surfaces 32 are being used simultaneously.

In the shown embodiment in FIG. 1a), the selection areas 42 are those touch-sensitive surfaces 32 located on the left side of the driver's seat 14 and the operating surfaces 43 are those touch-sensitive surfaces 32 located on the right side of the driver's seat 14.

As a result, the selection areas 42 and the operating areas 43 are provided on different sides of the driver's seat 14.

To determine, on which side of the driver's seat 14 one of the touch-sensitive surfaces 32 is located, the position of the corresponding touch-sensitive surface 32 is viewed from the centerline of the driver's seat 14 in the direction of travel. As this centerline also intersects the steering wheel 12, both at least a selection area 42 and at least an operating area 43 can be provided on the steering wheel 12. The steering wheel 12 is viewed in its non-rotated state.

Thus, the driver (when driving on the right) can easily reach the selection surfaces 42 with his left hand and can easily reach the operating surfaces 43 with his right hand.

Of course, the touch-sensitive surfaces 32 on the right side of the front passenger seat 16 can also be selection areas 42, thus the front passenger can also reach the selection areas 42, however with his right hand.

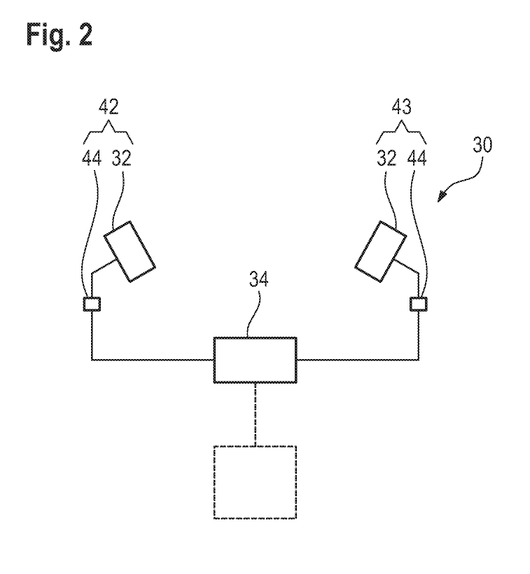

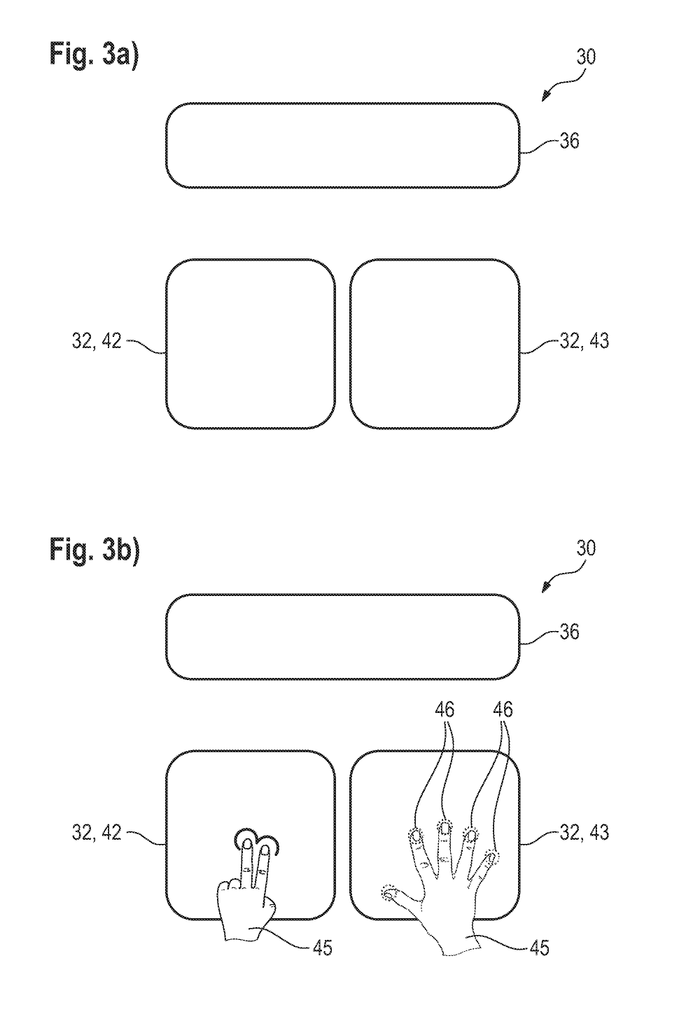

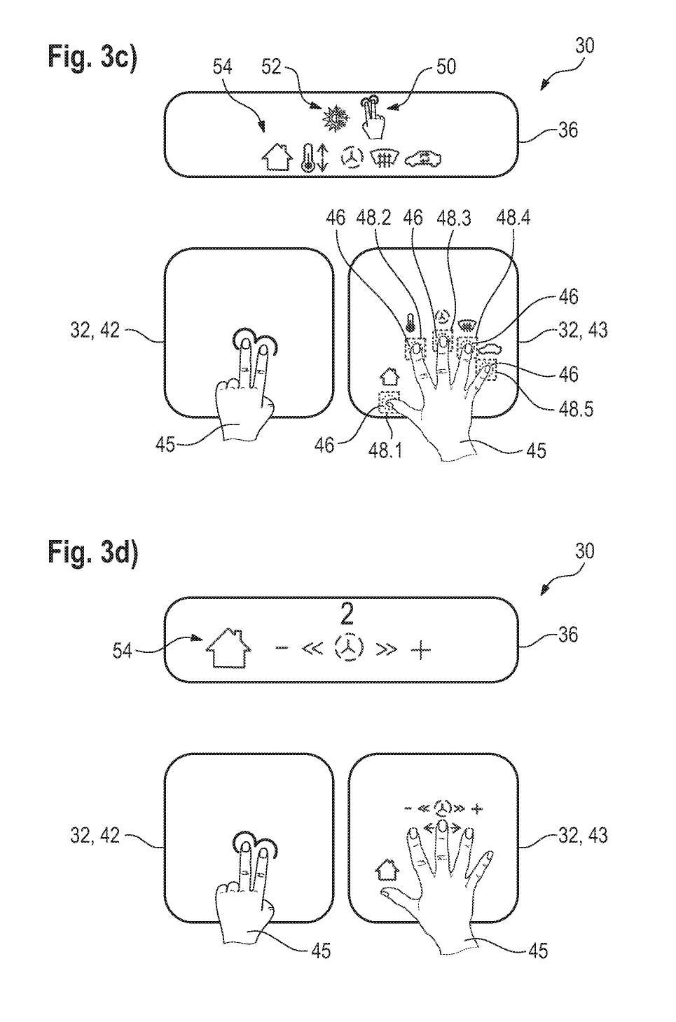

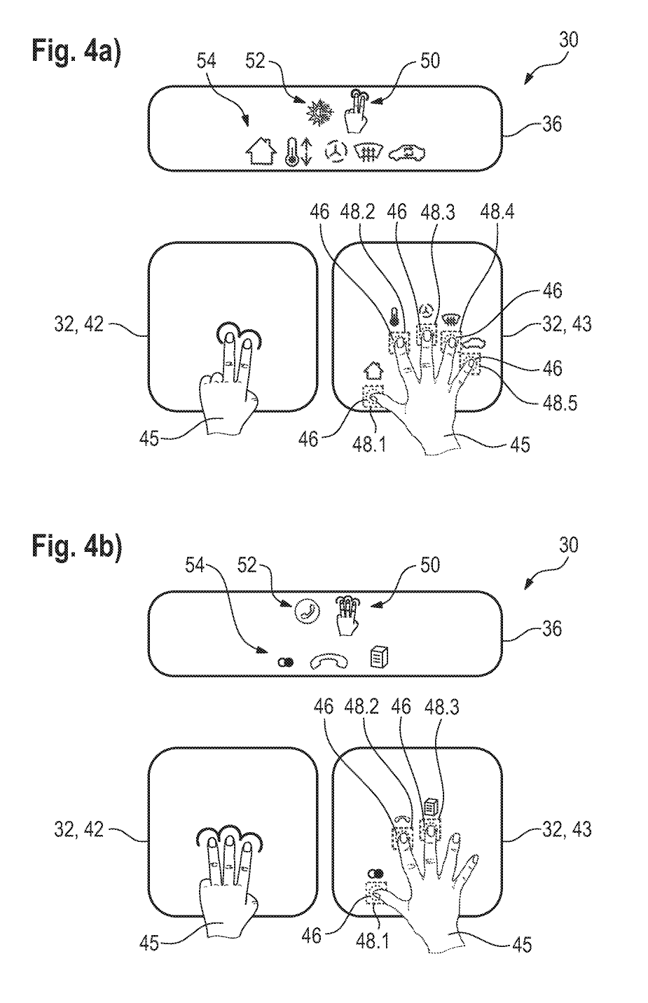

In FIG. 2, the configuration of the human machine interface 30 is shown schematically and greatly simplified comprising a selection area 42 and an operating area 43 that are connected to the control unit 34 by means of cables.

Both the selection area 42 as well as the operating area 43 each comprise a separate area controller 44 that controls the respective touch-sensitive surface 32. The area controller 44 recognizes touches on the respective touch-sensitive surface 32 and can recognize the number and position of said one touch or of several touches on the corresponding selection area 42 or operating area 43.

Both area controllers 44 are connected to the control unit 34 via cables in order to transmit information on the number and positions of the touches to the control unit 34.

The control unit 34 evaluates the information provided by the area controller 44 and executes functions. To this end, the control unit 34 can activate, for example, a vehicle control unit (represented as dashed lines).

Of course, the control unit 34 can even be integrated into the vehicle control unit.

It is conceivable that the area controllers 44 are integrated into the control unit 34.

In FIGS. 3a) to 3d) as well as 4a) and 4b), one of the selection areas 42 (bottom left), one of the operating areas 43 (bottom right) as well as part of the display of the output screen 36 (top) are schematically shown as an example to explain the method.

The shown configuration of the selection area 42, operating area 43 and the output screen 36 has only been selected for the purpose of compact representation. As can be seen in FIG. 1a), the space between these components is larger.

If the user of the human machine interface decides to execute a function, he does not normally touch any of the touch-sensitive surfaces 32 yet.

Neither the selection area 42 nor the operating area 43 are therefore touched at the beginning of the method and no information is also displayed on the output screen 36 (FIG. 3a).

If the user places his hand 45 on the operating surface 43, as shown in FIG. 3b), he touches the touch-sensitive surface 32 of the operating surface 43 with his five fingers simultaneously, thus generating five different contact points 46.

The user can place his hand on any location on the operating area 43 or his finger can touch the operating area 43 on any location without thus interfering with the method.

The touch of the fingers on the contact points 46 is recognized by the corresponding area controller 44 and information about this is transmitted to the control unit 34.

Thereupon, each button 48.1, 48.2, 48.3, 48.4, 48.5 (grouped together below under the reference sign 48) is assigned to these contact points 46. In addition, the position (for example the center) of a button 48 is set to one of the contact points 46 (cf. FIG. 3c).

The buttons 48 are thus assigned to individual contact points 46 and comprise the respective contact point 46. In short, buttons 48 and contact points 46 that are assigned to each other are located at the same position on the operating area 43.

The buttons 48 are designed larger than the contact points 46 in this regard so that the contact points 46 are completely enclosed. Moreover, the buttons 48 can have a round, in particular circular, or a quadratic contour.

Moreover, when fingers are placed on the operating surface 43, the control unit 34 can recognize which contact point 46 must correspond to which finger of a hand and thus assigns the corresponding finger to the contact points 46 and the assigned buttons 48.

The finger recognition takes place, for example, via an analysis of the position of the contact points 46 relative to each other as this is largely predetermined by human anatomy.

In this regard, the control unit 34 only considers such touches or contact points 46 that have been caused by the touch of a finger.

It is also conceivable that the control unit 34 recognizes whether the operating surface 43 is operated by a left or a right hand.

Furthermore, a function is assigned to the buttons 48 by the control unit 34, through said function the corresponding vehicle component 10 or another component of the vehicle is actuated.

The components of the vehicle are, for example, the navigation system, the entertainment system, the air-conditioning system, the telephone system and vehicle components, such as an air suspension system, seats or the like.

The allocation or the selection of functions is carried out via the control unit 34 depending on the touches on the selection area 42.

In the shown embodiment, the user touches the selection area 42 with two fingers, thus generating two different contact points 46.

Even on the selection area 42, it is possible for the user to place his fingers on any location.

The touch of the fingers on the selection area 42 or the contact points 46 are recognized by the area controller 44 and transmitted to the control unit 34. The control unit 34 then determines the number of contact points 46 or fingers.

In this regard, the control unit 34 only considers such touches or contact points 46 that have been caused by the touch of a finger. The recognition as to whether a contact point 46 has been generated by a finger or not can take place, for example, through a analysis of the position of the contact points 46 relative to each other as the position of the contact points 46 relative to each other is predetermined by human anatomy.

Even the size of the contact point 46 can be decisive. In this way, for example, the touch of the selection area 42 by the heel of the hand 45 can be recognized and ignored.

If the control unit 34 recognizes the number of contact points 46, thus here two contact points 46, it selects one of the set of functions assigned to the number of the fingers, said set of functions being stored for example in a memory of the control unit 34.

A set of functions comprises several functions, to each of which a button 48 on the operating area 43 is assigned, by means of which the corresponding function can be executed.

The functions within a set of functions are preferably thematically similar or concern the same components of the vehicle.

For example, the “change target temperature”, “change fan speed”, “window heater” and “circulating air mode” functions constitute functions of the “air-conditioning system” set of functions that are used for controlling the air-conditioning system.

Other sets of functions are, for example, “navigation”, “entertainment”, “telephony” and “car settings”.

In the shown embodiment, a touch of the selection area 42 on two contact points 46 is assigned to the “air-conditioning system” set of functions which is selected by the control unit 34 accordingly.

The control unit 34 then displays on the output screen 36 both the number of recognized contact points 46, in this case by means of a corresponding hand icon 50, and the selected set of functions, in this case using a corresponding symbol 52.

Moreover, the functions are displayed by the control unit 34 by means of function symbols 54 that exist in the selected “air-conditioning system” set of functions.

Each of these functions is assigned to a finger or rather a button 48 on the operating area 43.

In the shown embodiment, the thumb is assigned to the button 48.1 in FIG. 3c) and allocated as function the return to main menu. This function is symbolized on the output screen 36 by a small house.

In the same way, the index finger and the “change target temperature” function are assigned to the button 48.2; the middle finger and the “change fan speed” function are assigned to the button 48.3; the ring finger and the “window heater” function are assigned to the button 48.4, and the little finger and the function “circulating air mode” are assigned to the button 48.5.

All these functions are displayed on the output screen 36 by the function symbols 54. In this regard, the sequence of displayed functions, thus the function symbols 54, corresponds to the sequence of the fingers on the operating area 43.

At the same time, the function symbol 54 of the corresponding function can be displayed via the optical element 40 above each finger or above the button 48 in order to also indicate the functions of the buttons 48 on the operating area 43.

Moreover, the buttons 48 can be displayed on the optical element 40, for example, as a frame or highlighted area.

The user can now select the desired function by actuating the corresponding button 48. This is shown in the FIGS. 3c) and 3d), wherein a depiction of the contact points 46 and the buttons 48 has been forgone in FIG. 3d) for the sake of clarity.

For example, the user would like to turn up the ventilation. To this end, he operates the button 48.3 using his middle finger in order to select the “change fan speed” function so that he can adjust the power of the ventilation.

The user thus operates the button 48.3. This can be done, for example, by the user lifting his middle finger only briefly and placing it on the operating surface 43 again so that the button 48 is touched anew.

The position of this renewed touch is then assessed by the area controller 44 or by the control unit 34 and assigned to the button 48.3 so that the control unit 34 regards the button 48.3 as being actuated and executes the corresponding “change fan speed” function.

In this case, there is then a change to the menu for controlling the fan propeller.

This can be confirmed by the lighting up the symbol of the climate control on the output screen 36, thus providing the user with visual feedback.

When the button is actuated, the mechanical feedback element 41, in this case the vibration motor, is briefly activated so that the user receives a haptic feedback that he has just actuated the button 48.3.

However, it is also conceivable that the actuation must take place by increasing pressure, i.e. that the user increases the pressure on the touch-sensitive surface 32 in the area of the button 48.3 with his middle finger. This increase in pressure can be recognized, for example, through the expansion of the contact point 46 in the area of the middle finger. However, there are also other possible ways of recognizing an increase in pressure.

The user thus accesses the menu according to FIG. 3d), with which he can adjust the speed of the fan propeller. To this end, the button 48.3 can be designed, for example, as a slider that the user can actuate by swiping or dragging his middle finger to the left or right, i.e. by shifting the contact point 46.

Alternatively or in addition, functions which increase or decrease the speed of the fan propeller incrementally can be assigned to the buttons 48.2 and 48.4 of the index or ring finger. This is displayed with a minus or plus symbol both on the output screen 36 and on the optical element 40.

In addition, the current speed setting can be indicated on the output screen 36. In this case, the speed setting is “2”.

The user thus achieves his goal, namely changing the power of the ventilation of the air-conditioning system. To this end, he does not have to feel for a physical button or find a specific button with his finger because the buttons 48 have each been set by the control unit 34 to the contact points 46 of the fingers of his hand.

The user received an optical check or feedback on his action entirely through the output screen 36 that is on the dashboard 22 or in the head-up display 38 so that he only has to turn his gaze away from the road for a brief moment. As a result, he can execute the desired task without any great loss of attention.

Moreover, the user can switch between different sets of functions quickly, as can be seen in FIG. 4.

FIG. 4a) corresponds to FIG. 3c), the user thus touches the selection area 42 with two fingers of the left hand and the operating area 43 with all fingers of the right hand. As a result, the “air-conditioning system” set of functions is activated.

However, the user would now like to end his current telephone conversation and does not want to control the air condition system any more.

To this end, the user uses a third finger of his left hand and uses it to additionally touch the selection area 42 so that there are now three contact points 46 on the selection area 42 (cf. FIG. 4b).

As the control unit 34 or the area controller 44 repeatedly, for example continuously or periodically, determines the number of contact points 46 or fingers on the section area 42, it also registers that the number has changed.

Accordingly, the control unit 34 then selects the set of functions that is assigned to three fingers on the selection area 42 and assigns the functions to the corresponding buttons 48 and updates the output of the output screen 36.

The set of functions and thereby the functions of the buttons 48 are thus selected based on the number of contact points on the selection area 42 that have been determined during the period of the touch on the operating surface 43.

In the shown embodiment, the “telephony” set of functions are assigned to three fingers on the selection area 42. The “telephony” set of functions comprises, for example, three functions, namely “redial”, “hang up” and “telephone directory”.

These functions are assigned to the adjacent buttons 48.1, 48.2 and 48.3 or rather the adjacent contact points 46. The contact points 46 are generated by touching with the thumb, index finger and middle finger.

The user can now end his telephone conversation with the index finger of his right hand by actuating the button 48.2.

In another embodiment, each set of functions only comprises three functions that are assigned to the buttons 48.1, 48.2 and 48.3 of the thumb, index finger and middle finger. As a result, the speed of the human machine interface 30 can be increased and the operability improved as users can have difficulties moving their ring fingers or small fingers separately. The remaining buttons 48.4 and 48.5 are not generated in this case.

It is also conceivable that the number of fingers or rather the number of contact points 46 on the selection area 42 are determined only at a single point in time. The functions are then selected by the control unit 34 based on the number of contact points 46 or fingers. For example, the point in time can be the point in time when the operating surface 43 is touched again for the first time after a period without being touching, or it can be a point in time that is a predetermined time interval before a renewed touch of the operating surface 43. As a result, it is not necessary for the user to have both hands constantly placed on the selection area 42 or the operating area 43.

The set of functions or the functions can also be additionally selected by the control unit 34 depending on other parameters.

Whether a right or a left hand rests on the selection area 42 and/or the operating area 43 can also be determined, for example, by the control unit 34 based on the positions of the contact points 46 to each other.

This is necessary, for example, to be able to always assign that function that the user associates with the corresponding finger to the fingers. For example, to ensure that the user always returns to the main menu by actuating the button beneath his thumb.

The information whether a left or right hand rests on the touch-sensitive surface 32 can also be used to select the functions or the set of functions that are assigned to the buttons 48.

For example, if the touch-sensitive surface 32 is installed on the center console 24 in a vehicle that is designed for right-hand traffic, the driver operates the touch-sensitive surface 32 with his right hand, however, the front passenger only with his left hand.

Based on the used hand 45, the control unit 34 can thus recognize whether the driver or the front passenger is operating the touch-sensitive surface 32.

As a result, different functions for the driver and front passenger can be then assigned to the buttons 48. For example, the front passenger can only change the climatic zone for the front passenger seat.

It is also conceivable that the set of functions or the functions are selected depending on which finger or fingers is or are touching the selection area 42.

1. A method for operating a human machine interface for a vehicle comprising a control unit and at least one selection area designed as a touch-sensitive surface and at least one operating area designed as a touch-sensitive surface, wherein said at least one selection area and said at least one operating area are separated from each other, comprising the following steps:
a) a touch on at least one arbitrary contact point of said at least one operating area is recognized,
b) the number of fingers touching said at least one selection area is determined, and
c) a button, by means of which an input is possible, is assigned to said at least one arbitrary contact point on said at least one operating area,
wherein a function is assigned to the button, said function being selected depending on the number of fingers that touch said at least one selection area.

2. The method according to claim 1, wherein the number of fingers on the selection area is used for selecting the function of the button, said number of fingers being determined the moment the operating area is touched, a predetermined period before or during the period of the touch.

3. The method according to claim 1, wherein the number of fingers on the selection area is determined repeatedly anew and the function of the button is adapted if necessary.

4. The method according to claim 1, wherein several simultaneous touches are recognized, wherein at least the contact points on the operating area are each assigned a button each comprising one function.

5. The method according to claim 4, wherein several simultaneous by several fingers on several contact points of the operating area are recognized.

6. The method according to claim 4, wherein the functions that are assigned to the different contact points when touched simultaneously constitute a set of functions, wherein the used set of functions was selected depending on the number of fingers on said at least one selection area.

7. The method according to claim 6, wherein each set of functions comprises three functions that are assigned to the buttons of three adjacent contact points.

8. The method according to claim 7, wherein the three buttons are the buttons whose contact points have been generated by the thumb, index finger or middle finger of the user's hand.

9. The method according to claim 1, wherein the finger operating at least one of the selection area and the operating area is recognized, wherein at least one of the function and the set of functions are selected depending on the finger used.

10. The method according to claim 1, wherein the hand operating at least one of the selection area and the operating area is recognized, wherein at least one of the function and the set of functions are selected depending on the hand used.

11. A human machine interface for a vehicle, comprising a control unit and at least one selection area designed as a touch-sensitive surface and at least one operating area designed as a touch-sensitive surface, wherein said at least one selection area and said at least one operating area are separated from each other and connected to the control unit for the purpose of transmitting data,
wherein at least one button, to which a function is assigned, is provided on the operating surface during operation of the human machine interface, said function being selected depending on the number of fingers on said at least one selection area.

12. The human machine interface according to claim 11, wherein at least one of the selection area and the operating area comprise an area controler that recognizes the number and position of at least one touch on the selection area or operating area assigned to it, wherein the area controller is connected to the control unit in order to transmit the number and the position of the at least one touch on the touch-sensitive surface assigned to it.

13. The human machine interface according to claim 11, wherein the position of the button is determined by the control unit in such a way that on touching the operating surface on any contact point, the position of the button is set by the control unit to the contact point that was touched.

14. The human machine interface according to claim 11, wherein said at least one button is operatable via at least one of renewed touch, increasing the pressure and shifting the contact point.

15. The human machine interface according to claim 11, wherein the selection area and the operating area are provided on different sides of a seat.

16. The human machine interface according to claim 15, wherein the selection area and the operating area are provided on different sides of the driver's seat.

17. The human machine interface according to claim 11, wherein the human machine interface comprises at least a vehicle component, wherein the selection area and the operating area are located on said at least one vehicle component, in particular wherein several vehicle components are provided, wherein the selection area and the operating area are located on different vehicle components.

18. The human machine interface according to claim 17, wherein several vehicle components are provided, wherein the selection area and the operating area are located on different vehicle components.

19. The human machine interface according to claim 17, wherein the vehicle component is at least one of a steering wheel, a seat, a control stick, door trim, an armrest, a part of a center console, a part of a dashboard and a part of an overhead trim.

20. The human machine interface according to claim 11, wherein the human machine interface comprises an output screen that is located spatially separated from at least one of the selection area, the operating area and the vehicle component, wherein the function of said at least one button is displayed on the output screen.
